(19) United States
(12) Patent Application Publication
(10) Pub. No.: US 2025/0035599 A1
(43) Pub. Date: Jan. 30, 2025

(54) SYSTEMS AND METHODS FOR AUTOMATED GAS CHROMATOGRAPHY PEAK ALIGNMENT

(71) Applicant: REGENTS OF THE UNIVERSITY OF MICHIGAN, Ann Arbor, MI (US)

(72) Inventors: Sardar Ansari, Ypsilanti, MI (US); Kevin R. Ward, Superior Township, MI (US); Xudong Fan, Saline, MI (US); Wenzhe Zang, Ann Arbor, MI (US); Ruchi Sharma, Ann Arbor, MI (US); Loc Cao, Ann Arbor, MI (US)

(21) Appl. No.: 18/782,334

(22) Filed: Jul. 24, 2024

Related U.S. Application Data
(60) Provisional application No. 63/528,570, filed on Jul. 24, 2023.

(51) Int. Cl. G01N 30/86; G01N 30/02; G01N 30/88

(52) U.S. Cl. CPC G01N 30/8693; G01N 30/8658; G01N 30/8679; G01N 30/8696; G01N 30/88; G01N 2030/025; G01N 2030/884

(57) ABSTRACT

Systems and methods for aligning gas chromatography peaks are disclosed. An example method includes receiving chromatographic data of a user that includes data representing at least one volatile organic compound (VOC), and analyzing the chromatographic data using a trained peak alignment model to output a set of peak match probabilities. The trained peak alignment model may be trained using a plurality of chromatographic data to output a plurality of peak match probabilities. The example method may further include generating a set of identified VOCs between the chromatographic data and a set of reference VOCs by applying a post-processing algorithm to the set of peak match probabilities; and causing the set of identified VOCs to be displayed to the user.

### CROSS-REFERENCE TO RELATED APPLICATIONS

This application claims priority to U.S. Provisional Application No. 63/528,570, entitled “Systems and Methods for Automated Gas Chromatography Peak Alignment,” filed Jul. 24, 2023, and is related to U.S. Provisional Application No. 63/604,323, entitled “Deep Learning Approach for Automated Gas Chromatography Peak Detection to Account for Co-Elution,” filed Nov. 30, 2024, the contents of each of which are incorporated herein by reference.

### STATEMENT REGARDING FEDERALLY SPONSORED RESEARCH OR DEVELOPMENT

This invention was made with government support under TR003812 awarded by the National Institutes of Health. The government has certain rights in the invention.

### FIELD OF THE DISCLOSURE

The present disclosure relates generally to techniques for gas chromatography and, more particularly, to systems and methods for automated gas chromatography peak alignment leveraging a deep learning approach using optimization.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

The clinical significance of volatile organic compounds (VOC) in detecting diseases has been established over the past several decades. Gas chromatography (GC) devices generally enable measurement of these VOCs, such as through human breath analysis. With the rise of portable GC devices, breath analysis has become attractive as a non-invasive method for point-of-care diagnosis of various diseases including asthma, acute respiratory distress syndrome, and COVID-19, among others. In particular, breath VOCs have been shown to have a significant diagnostic power for such diseases.

Broadly speaking, a GC device measures the VOCs in an exhaled breath, which can then be used to differentiate healthy and sick patients. The success of this diagnostic process is predicated, at least in part, on the ability to correctly identify the VOCs from the chromatogram signals. This can be challenging due to the drift of the peak retention times from one sample to another, which can lead to misidentification of VOCs. Hence, finding the correspondence between the chromatogram peaks and the peaks in a reference chromatogram (or those pre-stored in a library) is an important step before conducting any statistical analysis. However, conventional techniques suffer from several drawbacks that complicate and generally cause this process to be inconsistent.

Primary among these drawbacks is that conventional, semi-automated peak alignment algorithms require manual intervention by an operator, which is slow, expensive and inconsistent. For example, many conventional techniques utilize Dynamic Time Warping (DTW) and Correlation Optimized Warping (COW). DTW identifies a mapping between the unaligned chromatograms and reference chromatograms by minimizing the pointwise distance between the timing of both signals. COW divides the unaligned signal into equal segments and makes segment-wise comparisons to find the optimized segment length that maximizes the overall correlation. However, in both cases, several constraints are necessarily imposed to make the problems finite and solvable using dynamic programming, and it is unclear whether there exists an optimal, setting-independent set of optimization criteria.

Extensions of the conventional COW/DTW techniques have been proposed, but still require manual tuning of the algorithm's parameters to achieve optimal results. More recent deep-learning works have reframed peak alignment as a binary classification task, but these approaches require large, annotated datasets for model training. Such large training datasets are generally unavailable, and as a result, conventional machine learning approaches have minimal practical utility. This issue is acutely expressed by the significant proportion of false positives conventional machine learning techniques experience in chromatography peak alignment due to label imbalances and other issues stemming from inadequately small training datasets. Further, these conventional machine learning techniques have been limited to validations on simple datasets with a small number of VOCs (e.g., approximately 10 VOCs), and are difficult to extend to chromatographic data with large numbers of VOCs (e.g., greater than 100 VOCs).

Additionally, conventional techniques typically suffer from a lack of usability as a consequence of their data intake. These conventional techniques often utilize two-dimensional data in the form of gas chromatography data and mass spectroscopy data. Such an approach generally requires significantly sophisticated, large, and/or otherwise impractical devices to perform the data intake and yield meaningful results. Thus, these conventional techniques frequently suffer from a lack of applicability in situations where additional factors make such large/impractical devices undesirable, such as when device portability is paramount.

Therefore, there is a need for techniques capable of accurately and efficiently aligning peaks in complex gas chromatography signals to enable more accurate and reliable diagnosis and management of various diseases.

### SUMMARY OF THE INVENTION

According to an aspect of the present disclosure, a method for aligning gas chromatography peaks is disclosed herein. The method may comprise: receiving, at one or more processors, chromatographic data of a user that includes data representing at least one volatile organic compound (VOC); analyzing, by the one or more processors, the chromatographic data using a trained peak alignment model to output a set of peak match probabilities, wherein the peak alignment model is trained using a plurality of training chromatographic data to output a plurality of training sets of peak match probabilities; generating, by the one or more processors, a set of identified VOCs between the chromatographic data and a set of reference VOCs by applying a post-processing algorithm to the set of peak match probabilities; and causing, by the one or more processors, the set of identified VOCs to be displayed to the user.

In a variation of this aspect, the method may further comprise: generating, by the one or more processors, a set of simulated chromatograms based on a set of reference chromatograms, and wherein the plurality of training chromatographic data is the set of simulated chromatograms.

In another variation of this aspect, the chromatographic data may be a one-dimensional (1D) chromatogram.

In yet another variation of this aspect, the trained peak alignment model may be a deep learning model including one or more of: (i) a convolutional neural network (CNN), (ii) a recurrent neural network (NN), (iii) a long short-term memory network, (iv) a gated recurrent unit (GRU), or (v) a transformer network.

In still another variation of this aspect, the post-processing algorithm is at least one of: (i) a greedy optimization algorithm, (ii) an Integer Program algorithm, or (iii) a Naïve Bayes algorithm.

In yet another variation of this aspect, applying the post-processing algorithm may further comprise: determining, by the one or more processors, whether a chronology of the chromatographic data corresponds to a predetermined chronology of the set of reference VOCs. Further in this variation, the method may further comprise: analyzing, by the one or more processors, the set of identified VOCs to determine whether any peaks from the chromatographic data are orphan peaks (e.g., not assigned to any VOCs); and responsive to determining that (i) the chronology corresponds to the predetermined chronology and (ii) no peaks from the chromatographic data are orphan peaks, generating, by the one or more processors, the set of identified VOCs.

In still another variation of this aspect, the method may further comprise: receiving, at the one or more processors, updated chromatographic data associated with the user; analyzing, by the one or more processors, the updated chromatographic data using the trained peak alignment model to output an updated set of peak match probabilities; generating, by the one or more processors, a set of updated identified VOCs between the updated chromatographic data and the set of reference VOCs by applying the post-processing algorithm to the updated set of peak match probabilities; and generating, by the one or more processors, a shortened listing of matched diseases based on the set of identified VOCs and the set of updated identified VOCs.

In another aspect of the present disclosure, a system for aligning gas chromatography peaks is disclosed herein. The system may comprise: a memory storing a set of computer-readable instructions; and one or more processors interfacing with the memory, and configured to execute the set of computer-readable instructions to cause the one or more processors to: receive chromatographic data of a user that includes data representing at least one volatile organic compound (VOC), analyze the chromatographic data using a trained peak alignment model to output a set of peak match probabilities, wherein the trained peak alignment model is trained using a plurality of training chromatographic data to output a plurality of training sets of peak match probabilities, generate a set of identified VOCs between the chromatographic data and a set of reference VOCs by applying a post-processing algorithm to the set of peak match probabilities, and cause the set of identified VOCs to be displayed to the user.

In a variation of this aspect, the instructions, when executed, may further cause the one or more processors to: generate a set of simulated chromatograms based on a set of reference chromatograms, and wherein the plurality of training chromatographic data is the set of simulated chromatograms.

In another variation of this aspect, the chromatographic data may be a one-dimensional (1D) chromatogram.

In yet another variation of this aspect, the trained peak alignment model may be a deep learning model including one or more of: (i) a convolutional neural network (CNN), (ii) a recurrent neural network (NN), (iii) a long short-term memory network, (iv) a gated recurrent unit (GRU), or (v) a transformer network.

In still another variation of this aspect, the post-processing algorithm may be at least one of: (i) a greedy optimization algorithm, (ii) an Integer Program algorithm, or (iii) a Naïve Bayes algorithm.

In yet another variation of this aspect, applying the post-processing algorithm may further comprise: determining whether a chronology of the chromatographic data corresponds to a predetermined chronology of the set of reference VOCs. Further in this variation, the instructions, when executed, may further cause the one or more processors to: analyze the set of identified VOCs to determine whether any peaks from the chromatographic data are orphan peaks (e.g., not assigned to any VOCs); and responsive to determining that (i) the chronology corresponds to the predetermined chronology and (ii) no peaks from the chromatographic data are orphan peaks, generate the set of identified VOCs.

In yet another aspect of the present disclosure, a non-transitory computer-readable storage medium having stored thereon a set of instructions, executable by at least one processor, for aligning gas chromatography peaks is disclosed herein. The instructions may comprise: instructions for receiving chromatographic data of a user that includes data representing at least one volatile organic compound (VOC); instructions for analyzing the chromatographic data using a trained peak alignment model to output a set of peak match probabilities, wherein the trained peak alignment model is trained using a plurality of training chromatographic data to output a plurality of training sets of peak match probabilities; instructions for generating a set of identified VOCs between the chromatographic data and a set of reference VOCs by applying a post-processing algorithm to the set of peak match probabilities; and instructions for causing the set of identified VOCs to be displayed to the user.

In a variation of this aspect, the instructions may further comprise: instructions for generating a set of simulated chromatograms based on a set of reference chromatograms, and wherein the plurality of training chromatographic data is the set of simulated chromatograms.

In another variation of this aspect, the chromatographic data may be a one-dimensional (1D) chromatogram.

In yet another variation of this aspect, the trained peak alignment model may be a deep learning model including one or more of: (i) a convolutional neural network (CNN), (ii) a recurrent neural network (NN), (iii) a long short-term memory network, (iv) a gated recurrent unit (GRU), or (v) a transformer network.

In still another variation of this aspect, the post-processing algorithm may be at least one of: (i) a greedy optimization algorithm, (ii) an Integer Program algorithm, or (iii) a Naïve Bayes algorithm.

In yet another variation of this aspect, applying the post-processing algorithm may further comprise: (a) instructions for determining whether a chronology of the chromatographic data corresponds to a predetermined chronology of the set of reference VOCs; (b) instructions for analyzing the set of identified VOCs to determine whether any peaks from the chromatographic data are orphan peaks (e.g., not assigned to any VOCs); and responsive to determining that (a) and (b) are satisfied, instructions for generating the set of identified VOCs.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1A illustrates an example environment for aligning gas chromatography peaks, in accordance with various aspects disclosed herein.

FIG. 1B illustrates an example system for aligning gas chromatography peaks including components of the example environment of FIG. 1A, and in accordance with various aspects disclosed herein.

FIG. 2A illustrates a first example peak alignment model trained to align gas chromatography peaks, in accordance with various aspects disclosed herein.

FIG. 2B illustrates a second example peak alignment model trained to align gas chromatography peaks, in accordance with various aspects disclosed herein.

FIG. 2C illustrates a third example peak alignment model trained to align gas chromatography peaks, in accordance with various aspects disclosed herein.

FIG. 3 illustrates an example data workflow for aligning gas chromatography peaks, as utilized by the example system of FIG. 1B, and in accordance with various aspects disclosed herein.

FIG. 4 illustrates an example method for aligning gas chromatography peaks, in accordance with various aspects disclosed herein.

FIG. 5 depicts an example user interface display enabling a user to view aligned gas chromatography peaks and a predicted diagnosis associated with VOCs corresponding to the aligned peaks, in accordance with various aspects disclosed herein.

FIG. 6 depicts an example disease and trajectory monitoring sequence, in accordance with various aspects disclosed herein.

### DETAILED DESCRIPTION

As previously mentioned, in gas chromatography (GC), conventional peak alignment techniques generally suffer from a lack of efficiency and accuracy due to manual intervention and/or inadequately trained machine learning models. The techniques of the present disclosure solve these issues associated with conventional techniques by providing a training pipeline for a deep-learning model that utilizes artificial chromatograms simulated from a small, annotated dataset, and a post-processing algorithm to generate VOC pairs. More specifically, the present disclosure introduces a peak alignment model that is trained using a plurality of training chromatographic data to output a plurality of training sets of peak match probabilities and a post-processing algorithm configured to generate a set of identified VOCs between chromatographic data and various VOCs represented by reference chromatograms. The peak alignment model, the post-processing algorithm, and the chromatogram simulation for training the peak alignment model collectively eliminate and/or reduce the drawbacks of conventional techniques by creating a more efficient and reliable VOC identification process for analyzing chromatographic data.

Thus, in accordance with the above, and with the disclosure herein, the present disclosure includes improvements in computer functionality or in improvements to other technologies at least because the disclosure describes that, e.g., a server (e.g., a central server), or otherwise computing device (e.g., a user computing device), is improved where the intelligence or predictive ability of the hosting server or computing device is enhanced by a trained peak alignment model and post-processing algorithm. These models/algorithms, executing on the server or user computing device, are able to accurately and efficiently determine VOCs represented by chromatographic data acquired from a user. That is, the present disclosure describes improvements in the functioning of the computer itself or “any other technology or technical field” because a server or user computing device, is enhanced with the trained peak alignment model and post-processing algorithm to accurately align chromatogram peaks with reference chromatogram peaks and identify VOCs that improve a user's ability to diagnose various diseases. This improves over the prior art at least because existing systems lack such evaluative and/or predictive gas chromatography peak alignment functionality, and are generally unable to accurately analyze chromatographic data to output predictive VOCs designed to improve a user/operator's overall diagnostic efforts related to various diseases.

As mentioned, the model(s) may be trained using machine learning and may utilize machine learning during operation. Therefore, in these instances, the techniques of the present disclosure may further include improvements in computer functionality or in improvements to other technologies at least because the disclosure describes such models being trained with a plurality of training data (e.g., 10,000s of training data corresponding to simulated chromatographic data, etc.) to output the identified VOCs configured to improve the user/operator's diagnostic efforts related to various diseases.

Moreover, the present disclosure includes effecting a transformation or reduction of a particular article to a different state or thing, e.g., transforming or reducing the peak alignment capabilities and VOC identification of a GC device from a non-optimal or error state to an optimal state by eliminating erroneous and/or otherwise irrelevant peak alignments and VOC associations.

Still further, the present disclosure includes specific features other than what is well-understood, routine, conventional activity in the field, or adding unconventional steps that demonstrate, in various embodiments, particular useful applications, e.g., analyzing, by the one or more processors, the chromatographic data using a trained peak alignment model to output a set of peak match probabilities, wherein the trained peak alignment model is trained using a plurality of simulated chromatographic data to output a plurality of training sets of peak match probabilities; generating, by the one or more processors, a set of identified VOCs between the chromatographic data and a set of reference VOCs by applying a post-processing algorithm to the set of peak match probabilities.

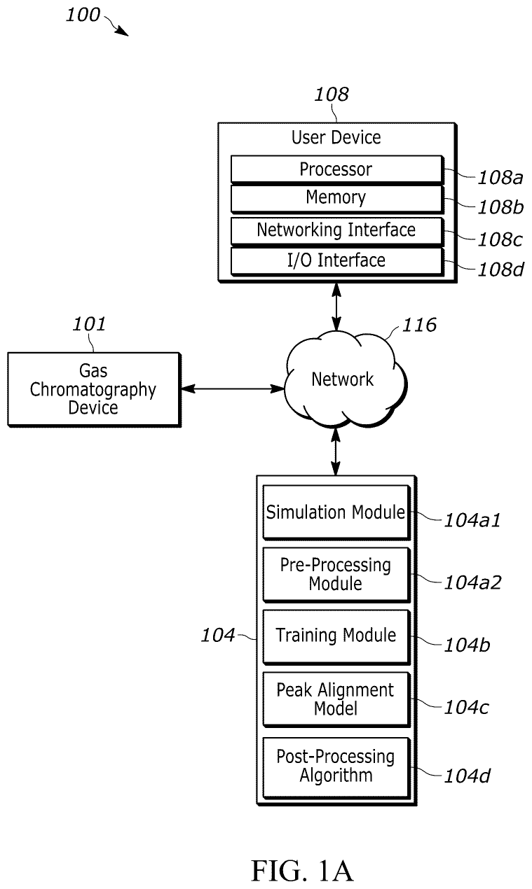

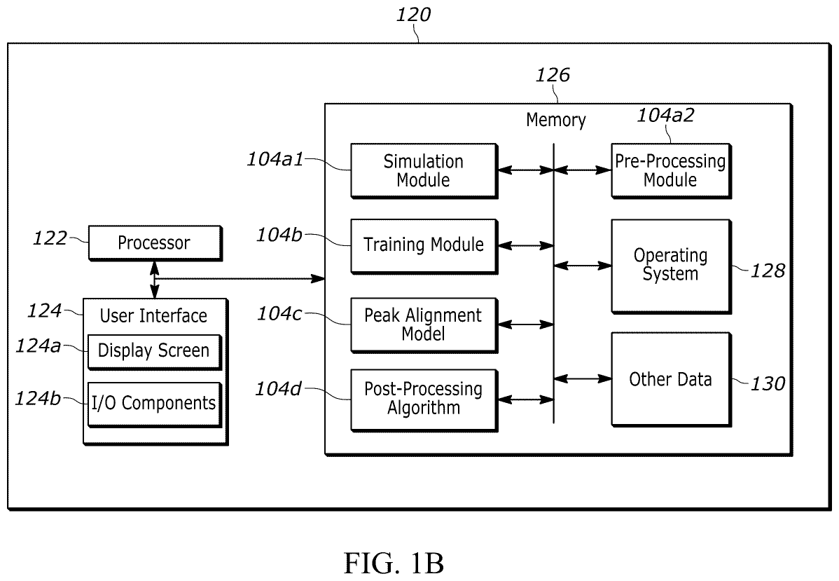

To provide a general understanding of the system(s)/components utilized in the techniques of the present disclosure, FIGS. 1A and 1B illustrate, respectively, a gas chromatography analysis system 104, and an example system 120 containing components of the gas chromatography analysis system 104 that are configured for aligning gas chromatography peaks. Accordingly, FIG. 1A provides a general overview of the gas chromatography analysis system 104 components, and FIG. 1B describes the components and their respective functions in greater detail. Moreover, it should be appreciated that the gas chromatography analysis system 104 may be incorporated as part of the example system 120, and/or the example system 120 may be the gas chromatography analysis system 104.

In any event, FIG. 1A illustrates an example environment 100 for aligning gas chromatography peaks, in accordance with various aspects disclosed herein. It should be appreciated that the example environment 100 and gas chromatography analysis system 104 are merely examples and that alternative or additional embodiments are envisioned.

In reference to FIG. 1A, the example environment 100 may be a laboratory, a physician's office, and/or any other suitable location in which a gas chromatography (GC) device 101 may be used. In particular, the example environment 100 includes the gas chromatography (GC) device 101, a server 104, and a user device 108. Broadly, the GC device 101 may receive breaths from a user (e.g., a user may exhale into the GC device 101), the GC device 101 may output chromatographic data to the server 104 across the network 116, and the server 104 may output VOC pairs, chromatographic data, and/or any other suitable information to the user device 108. The user device 108 may, for example, display the data output from the server 104 for viewing by a user, such as the user that exhaled into the GC device 101. In certain embodiments, the server 104 and the user device 108 may be integrated into a single device or system, such as a workstation in a physician's office. As referenced herein “chromatographic data” may be or include data representative of and/or otherwise extracted from any human and/or otherwise generated vapor space, such as from exhaled breath, wounds, skin, sweat, open/closed cavities (e.g., intestines/stomach, etc.), urinary catheter bags, and/or any other suitable space or combinations thereof. Further, “training data” or “training chromatographic data” may be or include simulated chromatographic data (e.g., as generated by the simulation module 104a1), non-simulated chromatographic data, sets of peak match probabilities, and/or any other suitable data described herein or combinations thereof.

Generally speaking, the GC device 101 may be any device that is configured to perform the separation and detection of VOCs within a gas sample. The GC device 101 may perform these actions in any suitable number of dimensions (e.g., 1D, 2D, 3D) but for ease of discussion, the GC device 101 may be referenced herein as a one-dimensional (1D) GC device 101. 1D GC generally involves sample (e.g., user breath(s)) and carrier gas injection into the GC device 101 column (not shown), after which, the sample and carrier gas naturally separate as they move towards the column exit. When the sample and/or carrier gas reach the column exit, the gases are detected by a detector (not shown) along with a timestamp representative of the retention time of the gas within the column. The detection and timestamp signals (collectively referenced herein as “chromatographic data”) from the detector may be transmitted to the server 104 for further analysis, and the resulting chromatogram may represent the separation of the various compounds contained in the sample along with the relative abundance of each compound.

For example, the GC device 101 may transmit the chromatographic data to the server 104, where the server 104 may apply/utilize the simulation module 104a1, the preprocessing module 104a2, the training module 104b, the peak alignment model 104c, and/or the post-processing algorithm 104d to the chromatographic data. The server 104 may input the chromatographic data into the peak alignment model 104c, and the model 104c may output a set of peak match probabilities that generally represent a likelihood that a particular peak present within chromatographic data from a user corresponds to a reference peak within a reference chromatogram that is associated with a known VOC. To illustrate, the peak alignment model 104c may receive chromatographic data of a user that includes 100 distinct peaks, and may output a set of peak match probabilities that includes a respective peak match probability for each of the 100 peaks. Further, each peak within the chromatographic data may have multiple peak match probabilities corresponding to respective likelihoods that the peak corresponds to various peaks within a single reference chromatogram and/or multiple different chromatograms.

In any event, when the peak alignment model 104c outputs the set of peak match probabilities, the server 104 may continue to process the set of peak match probabilities by executing the post-processing algorithm 104d. The post-processing algorithm 104d may be or include instructions that optimize the peak matching predicted by the peak alignment model 104c. In particular, the post-processing algorithm 104d may be an optimization algorithm (e.g., greedy optimization algorithm, discrete optimization techniques, etc.) that reduces the rate of false positives identified by the peak matching algorithm 104c through the application of several conditional parameters. For example, the post-processing algorithm 104d may cause the server 104 to determine whether a chronology of the chromatographic data corresponds to a predetermined chronology of the set of reference VOCs, whether any peaks from the chromatographic data are orphan peaks, and/or any other suitable criteria or set of criteria.

Moreover, the server 104 may include a simulation module 104a1, a preprocessing module 104a2, and a training module 104b that may generally be configured to collectively train the peak alignment model 104c. The simulation module 104a1 may receive input data (e.g., reference chromatograms) and may generate multiple simulated chromatograms based on those reference chromatograms that are used to train the peak alignment model 104c. The preprocessing module 104a2 may perform several actions with respect to the input data, the simulated chromatograms, and the chromatographic data input to the peak alignment model 104c, such as baseline removal, smoothing, peak detection, and/or peak deconvolution. The peak alignment model 104c may generally implement and be trained using machine learning (ML) techniques, and the training module 104b may utilize input training data (e.g., sets of simulated and preprocessed chromatograms from the simulation module 104a1 and preprocessing module 104a2) to train the model 104c to generate the training outputs (e.g., training sets of peak match probabilities).

In any event, the VOCs and/or the chromatographic data may be transmitted from the server 104 to the user device 108 for display and/or interaction with a user. The user device 108 may generally be a mobile device, laptop/desktop computer, wearable device, and/or any other suitable computing device that may enable a user to view the data transmitted from the server 104. The user device 108 may include one or more processors 108a, a memory 108b, a networking interface 108c, and an input/output (I/O) interface 108d. The user device 108 may receive the VOCs and/or chromatographic data from the server 104 via the networking interface 108c, and may display the data to the user via a display or other output device that is included as part of the I/O interface 108d. In certain embodiments, the user may interact with the user device 108 to view various aspects of the data received from the server 104, communicate with the server 104, and/or perform other actions (e.g., contacting a physician's office) in response to receiving the user interaction.

To provide a better understanding of the server 104 functionality, FIG. 1B illustrates an example system 120 for aligning gas chromatography peaks including components of the example environment of FIG. 1A, and in accordance with various aspects disclosed herein. In FIG. 1B, the example system 120 may be an integrated processing device of the server 104 that includes a processor 122, a user interface 124, and a memory 126. The memory 126 may store the simulation module 104a1, the preprocessing module 104a2, the training module 104b, the peak alignment model 104c, and the post-processing algorithm 104d, such that the example system 120 may include the components of the server 104 in FIG. 1A. The memory 126 may also store an operating system 128 capable of facilitating the functionalities as discussed herein, as well as other data 130.

Generally, the processor 122 may interface with the memory 126 to access/execute the operating system 128, the other data 130, the simulation module 104a1, the preprocessing module 104a2, the training module 104b, the peak alignment model 104c, and/or the post-processing algorithm 104d. The other data 130 may include a set of applications configured to facilitate the functionalities as discussed herein, and/or may include other relevant data, such as display formatting data, etc. For example, the processor 122 may access the operating system 128 in order to execute applications included as part of the other data 130, such as a GC device overview application (not shown) configured to facilitate functionalities associated with monitoring and adjusting parameters associated with a GC device (e.g., central GC device 101) to which the example system 120 is communicatively connected, as discussed herein. As another example, the other data 130 may include operational data associated with the GC device (e.g., column temperature, etc.), and/or any other suitable data or combinations thereof. It should be appreciated that one or more other applications are envisioned. Moreover, it should be understood that any processor (e.g., processor 122), user interface (e.g., user interface 124), and/or memory (e.g., memory 126) referenced herein may include one or more processors, one or more user interfaces, and/or one or more memories.

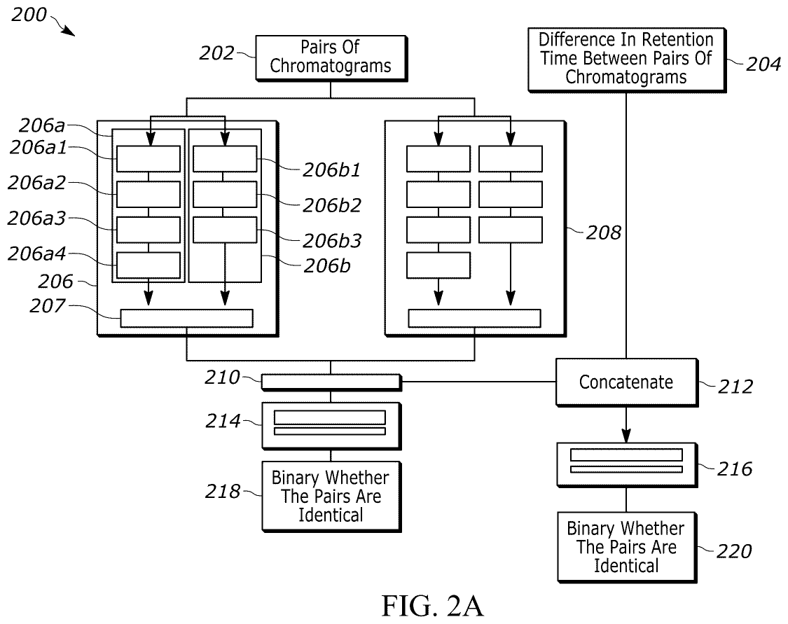

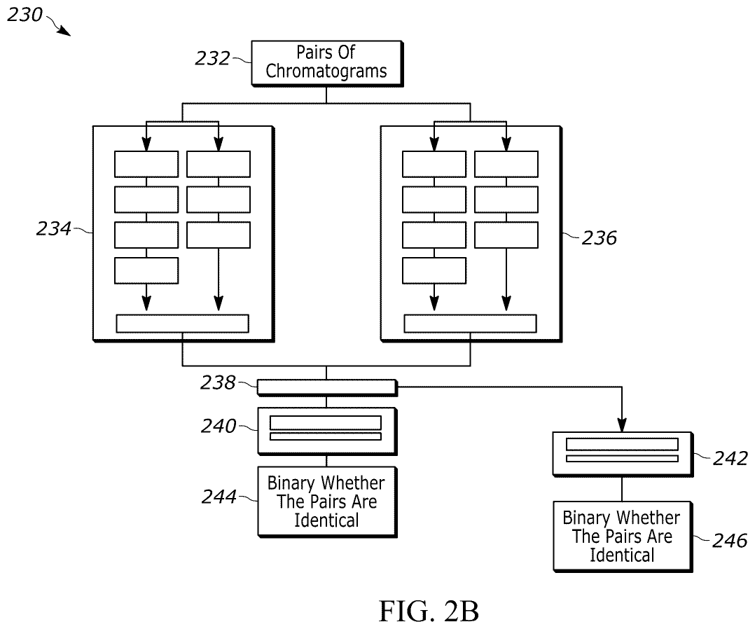

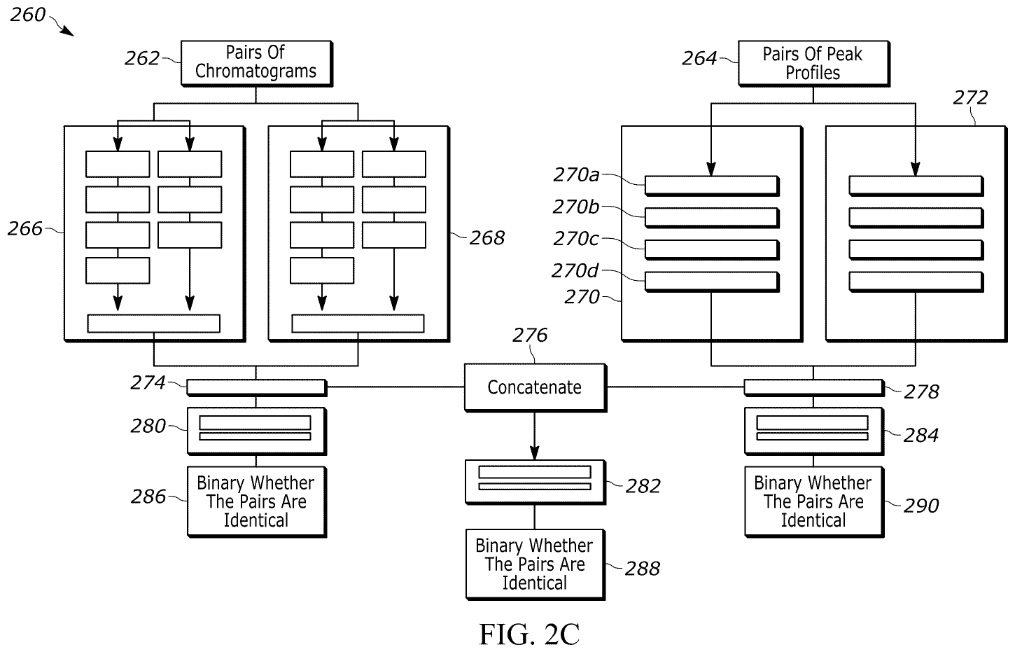

The processor 122 may access the memory 126 to execute the simulation module 104a1, the preprocessing module 104a2, the training module 104b, the peak alignment model 104c and/or the post-processing algorithm 104d to automatically analyze chromatographic data received from a GC device, and as a result, generate peak match probabilities and VOC pairings. Thus, for case of discussion, it should be understood that when referenced herein as the simulation module 104a1, the preprocessing module 104a2, the training module 104b, the peak alignment model 104c, and/or the post-processing algorithm 104d performing an action, the processor 122 may access and execute any of the instructions comprising the simulation module 104a1, the preprocessing module 104a2, the training module 104b, the peak alignment model 104c, and/or the post-processing algorithm 104d to perform the action. Moreover, reference to FIGS. 2A-2C may be made in order to help illustrate the concepts discussed herein.

The memory 126 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The example system 120 may further include a user interface 124 configured to present/receive information to/from a user. As shown in FIG. 1B, the user interface 124 may include a display screen 124a and I/O components 124b (e.g., ports, capacitive or resistive touch sensitive input panels, keys, buttons, lights, LEDs). According to some aspects, a user may access the example system 120 via the user interface 124 to review outputs from the forecasting engine 106, make various selections, and/or otherwise interact with the example system 120.

In some aspects, the example system 120 may perform the functionalities as discussed herein as part of a “cloud” network or may otherwise communicate with other hardware or software components within the cloud to send, retrieve, or otherwise analyze data. Thus, it should be appreciated that the example system 120 may be in the form of a distributed cluster of computers, servers, machines, or the like. In this implementation, a user may utilize the distributed example system 120 as part of an on-demand cloud computing platform. Accordingly, when the user interfaces with the example system 120 (e.g., by interacting with an input component of the I/O components 124b), the example system 120 may actually interface with one or more of a number of distributed computers, servers, machines, or the like, to facilitate the described functionalities.

In certain aspects, the example system 120 may communicate and interface with an external server and/or external devices (e.g., user device 108) via a network(s) (e.g., network 116). The network(s) used to connect the example system 120 to the external server/device(s) may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). Moreover, the external server/device(s) may include a memory as well as a processor, and the memory may store an operating system capable of facilitating the functionalities as discussed herein as well as the simulation module 104a1, the preprocessing module 104a2, the training module 104b, the peak alignment model 104c, and/or the post-processing algorithm 104d.

Additionally, it is to be appreciated that a computer program product in accordance with an aspect may include a computer usable storage medium (e.g., standard random access memory (RAM), an optical disc, a universal serial bus (USB) drive, or the like) having computer-readable program code embodied therein, wherein the computer-readable program code may be adapted to be executed by the processor(s) 122 (e.g., working in connection with the operating system 128) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some aspects, the computer program product may be part of a cloud network of resources.

In any event, the example system 120 may initially execute the simulation module 104a1, the preprocessing module 104a2, and the training module 104b to train the peak alignment model 104c, as previously mentioned. The simulation module 104a1 may receive an initial set of gas chromatograms, and may generate a set of simulated gas chromatograms that may be used as training data for the peak alignment model 104c. The preprocessing module 104a2 may perform baseline removal, smoothing, peak detection, and/or peak deconvolution on each of the initial set of gas chromatograms and/or the simulated gas chromatograms to clearly identify the peaks within the chromatograms. The training module 104b may receive the set of preprocessed, simulated gas chromatograms, and may proceed to train the peak alignment model 104c to output peak match probabilities based on input gas chromatograms generated based on chromatographic data from a user.

To facilitate the simulation module 104a1 functions, a relatively small set of gas chromatograms (e.g., less than 100 gas chromatograms) may be annotated and/or otherwise labelled manually to create an initial set of chromatograms. Generally, gas chromatogram labelling is a labor-intensive task, such that large, annotated datasets needed for training machine learning models (e.g., deep learning neural networks) may be difficult to obtain. To overcome these challenges, the simulation module 104a1 may generate simulated gas chromatograms from the relatively small set of gas chromatograms, and may thereby augment the information collected from the annotated gas chromatograms. However, it should be appreciated that larger datasets of gas chromatograms may be used as part of the techniques disclosed herein and may supplement and/or reduce a number of simulated chromatograms required to adequately train the peak alignment model 104c.

For example, using the peak information extracted from the labelled set of gas chromatograms, the simulation module 104a1 may simulate a plurality (e.g., 10,000s) of simulated chromatograms in a stage-wise process. This stage-wise process may include at least two broadly defined stages: simulating the time warping and simulating the gas chromatogram peaks. The first stage involves dynamic warping quantification and warping combination. The dynamic warping quantification may generally include quantifying the temporal mapping between the retention times of gas chromatogram peaks from their initially unaligned locations to their corresponding aligned locations for each training gas chromatogram. The simulation module 104a1 may then simulate new warpings by combining (e.g., averaging) any suitable number of warpings randomly sampled from the set of training gas chromatograms. In certain embodiments, the number of warpings to be averaged can be drawn from a random distribution such as Poisson distribution, and/or may utilize any other suitable number of simulated warpings.

The second stage involves the simulation module 104a1 combining the new warpings simulated in the first stage with individual simulated gas chromatogram peaks. The simulation module 104a1 may generally determine that a peak is present within a simulated chromatogram using a probability distribution such as Bernoulli (m), where m is a predetermined value, e.g., the prevalence of the peak in the training set of gas chromatograms. If the peak is present, the simulation module 104a1 may generate the actual aligned and unaligned peaks using a parameterized function such as a Gaussian or an Exponentially modified Gaussian function. The simulation module 104a1 may also define simulated peak parameters (e.g., peak shape, peak amplitude, peak width, aligned location, etc.) by averaging the same parameters in n training gas chromatograms randomly sampled from the training set of gas chromatograms, where n is drawn from a random distribution such as Poisson. The simulation module 104a1 may generate the corresponding unaligned locations of the gas chromatogram peaks using the warpings obtained from the first stage.

When the simulation module 104a1 finishes generating the set of simulated gas chromatograms, the module 104a may transmit the full set of reference gas chromatograms (e.g., initial training gas chromatograms and simulated gas chromatograms) to the preprocessing module 104a2 and/or the training module 104b. The preprocessing module 104a2 may generally perform various actions on and/or with the simulated gas chromatograms, as described herein, such as baseline removal, smoothing, peak detection, and/or peak deconvolution to prepare them for use by the training module 104b. The training module 104b may broadly use the full set of reference gas chromatograms to train the peak alignment model 104c to receive a gas chromatogram as input and output peak match probabilities. These peak match probabilities may generally indicate a likelihood that a particular peak featured in a gas chromatogram corresponds to either a peak in a reference gas chromatogram and/or directly that the peak corresponds to a particular VOC. Of course, it should be appreciated that the simulation module 104a2 may perform the gas chromatogram simulation sequence described above in any suitable number of stages and/or may generate any suitable number of simulated gas chromatograms.

In any event, after generating the set of simulated gas chromatograms, the preprocessing module 104a2 may receive the simulated gas chromatograms from the simulation module 104a1 and proceed to adjust the simulated gas chromatograms by shifting each of the simulated gas chromatograms relative to the training (i.e., reference) gas chromatograms. The preprocessing module 104a2 may shift the simulated gas chromatograms such that a centroid (e.g., the mean of the peak locations) of the simulated and the reference gas chromatograms are aligned. This shifting to a common fixed centroid may reduce the overall distance of the unaligned and reference peaks and enable the peak alignment model 104c to perform a more efficient search for the correct alignment by limiting the size of the search space.

The training module 104b may then receive these shifted gas chromatograms from the preprocessing module 104a2 and proceed to analyze the peaks of the simulated unaligned gas chromatograms to evaluate their pairwise correspondence. For each reference peak (VOC), the training module 104b may randomly select a sample of peaks from all the peaks generated from the set of simulated gas chromatograms (e.g., sampling 200 peaks for a given VOC from 10,000 of simulated chromatograms). The training module 104b may then generate all possible pairwise combinations between these sampled peaks. Alternatively, the pairs can be formed between the simulated peaks and the peaks in the reference GC. The training module 104b may generate a labeling for each pair that may have a positive or negative value, and the module 104b may eliminate any pairs that are spaced further than a predetermined threshold (e.g., one minute) from one another, as these peaks likely fail to correspond to identical VOCs. The label may generally indicate whether the two peaks correspond to the same reference peak (VOC), and are therefore identical. The training module 104b may retain and/or otherwise store each pair with a positive label and may sample the negative pairs separately to achieve balance between the negative and positive samples, which may significantly improve the resulting peak alignment model 104c efficiency by having the same number of training samples per peak. With these pairings, the training module 104b may randomly select sample pairs to reduce the size of the training dataset if needed for computational reasons (e.g., memory or processing limitations).

In particular, the training module 104b may compare the different pairs of peaks by using the chromatogram segments surrounding each peak and the individual peak profile(s). These chromatogram segments may include any suitable number of samples within a gas chromatogram, such as a 600-sample window centered around the test peak. Moreover, the training module 104b may define and/or otherwise analyze the peak profile as a signal extending between and/or otherwise including a peak beginning and a peak end, which may be defined as a location on the peak corresponding to the maximum amplitude±the full width at half maximum (FWHM).

Generally speaking, the peak alignment model 104c may determine whether pairs of peaks from the input gas chromatogram(s) and the reference gas chromatograms are identical using any type of machine learning model or neural network that is designed for comparing inputs and determining their equivalence, such as Siamese networks. A Siamese network generally may be or include two identical branches that are composed of convolutional and/or recurrent layers. The model 104c may evaluate a relative similarity of the output of the two branches based on a distance measure, which will be optimized during the training process to maximize the peak alignment model's 104c performance. In particular, the training module 104b may tune this similarity metric such that the resulting, trained peak alignment model 104c may be optimized to learn different patterns in peak pairs fed to the two branches and output whether the samples in the comparison pairs are structurally identical.

For example, the training module 104b may select and/or train three different models using the simulated data, such as the peak alignment models 200, 230, 260 represented in FIGS. 2A-2C. One or all of these models 200, 230, 260, may be or be part of the peak alignment model 104c. Broadly, the training module 104b may train each model to receive a set of inputs 202, 204, 232, 262, 264, process those inputs through various convolutional blocks 206, 208, 234, 236, 266, 268, dense blocks 214, 216, 240, 242, 280, 282, 284, gated recurrent unit (GRU) blocks 270, 272, and/or various component layers 210, 212, 238, 274, 276, 278 to generate sets of peak match probabilities as outputs 218, 220, 244, 246, 286, 288, 290.

More specifically, the training module 104b may be configured to utilize artificial intelligence (AI) and/or machine learning (ML) techniques to train the peak alignment model 104c. The training module 104b may generally employ supervised or unsupervised machine learning techniques, which may be followed or used in conjunction with reinforced or reinforcement learning techniques. As noted above, in some embodiments, the server 104 or other computing device may be configured to implement machine learning, such that the server 104 “learns” to analyze, organize, and/or process data through the peak alignment model 104c without being explicitly programmed. Thus, the training module 104b may train the peak alignment model 104c to automatically analyze chromatographic data from a GC device (e.g., GC device 101), and thereby enable the server 104 to automatically process user chromatographic data without requiring manual intervention.

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks (CNN), deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning. Of course, it should be appreciated that the machine learning models and techniques utilized herein may be or include any suitable models or techniques, such as variations CNNs (e.g., residual neural network or attention-based network) and/or recurrent neural networks (RNNs) (e.g., long short-term memory networks, gated recurrent units (GRUs), transformer networks, and/or other networks with/without an attention mechanism).

In one embodiment, the training module 104b may employ supervised learning techniques, which involves identifying patterns in existing data to make predictions about subsequently received data. Specifically, the training module 104b may be “train” the peak alignment model 104c using training data, which includes example inputs (e.g., reference and/or simulated chromatograms) and associated example outputs (e.g., corresponding peak match probabilities and/or associated VOCs). Based upon the training data, the training module 104b may cause the peak alignment model 104c to generate a predictive function which maps outputs to inputs and may utilize the predictive function to generate machine learning outputs based upon data inputs. The example inputs and example outputs of the training data may include any of the data inputs or machine learning outputs described above. In the example embodiment, a processing element may be trained by providing it with a large sample of data with known characteristics or features.

In another embodiment, the training module 104b may employ unsupervised learning techniques, which involves finding meaningful relationships in unorganized data. Unlike supervised learning, unsupervised learning does not involve user-initiated training based upon example inputs with associated outputs. Rather, in unsupervised learning, the training module 104b may cause the peak alignment model 104c to organize unlabeled data according to a relationship determined by at least one machine learning method/algorithm employed by the training module 104b. Unorganized data may include any combination of data inputs and/or machine learning outputs as described above.

In yet another embodiment, the training module 104b may employ reinforcement learning techniques, which involves optimizing outputs based upon feedback from a reward signal. Specifically, the training module 104b may cause the peak alignment model 104c to receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Of course, other types of machine learning techniques may also be employed, including deep or combined learning techniques.

After training, the peak alignment model 104c and/or other machine learning programs (or information generated by such machine learning programs) may be used to evaluate additional data. Such data may be and/or may be related to chromatographic data and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs (e.g., trained peak alignment model 104c) may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the training module 104b may train the peak alignment model 104c to output peak match probabilities, associated VOCs, and/or any other values or combinations thereof using artificial intelligence (e.g., a machine learning model of the peak alignment model 104c) or, in alternative aspects, without using artificial intelligence.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

In any event, returning to FIGS. 2A-2C, each model 200, 230, 260, may include two convolutional neural network (CNN) blocks, as represented by the convolutional blocks 206, 208, 234, 236, 266, 268. Each of these CNN blocks may have an architecture with two stacks (e.g., first stack 206a, second stack 206b) for comparing different pairs of gas chromatogram segments. For ease of discussion, the first stack 206a and the second stack 206b may represent the general architecture and structural functionality of each CNN block 206, 208, 234, 236, 266, 268 for each model 200, 230, 260. However, it should be understood that any or all of the CNN blocks 206, 208, 234, 236, 266, 268 may include different architectures that function and/or are trained in different manners.

Regardless, the first stack 206a may generally include four blocks 206a1-4 of two CNN units, wherein each CNN unit may have a convolutional layer followed by a batch normalization and rectified linear unit (ReLu) activation layer. Each block 206a1-4 may also have a beginning and end demarcated by a global max pooling layer with a pool size of three for the first block 2061a1 and a size of two for the remaining blocks 206a2-4. The kernel size may be three, and the number of filters may double with the number of blocks 2061a1-4. The second stack 206b may generally include three blocks 206b1-3 of a single CNN unit, and the remaining configuration may be identical to the first stack 206a. Of course, the CNN block 206 (and any CNN block 208, 234, 236, 266, 268 discussed herein) may have any suitable number of blocks 206a1-4, 206b1-3, pool size, filters, and/or kernel size.

The two stacks 206a, 206b may then be flattened at block 207 and concatenated into a single tensor. The outputs from the two blocks 206, 208 may then be merged into a single tensor by taking the absolute element-wise difference at block 210, and the model 200 may then use this tensor in two distinct ways. First, the model 200 may input the tensor into a first dense layer 214 with 10 units, a dropout layer with a rate of 0.20 and a dense unit with a sigmoid activation that is configured to predict whether the two chromatogram segments are identical (represented by the output 218). Next, the model 200 may input the tensor into the main branch at block 212 that is configured to combine different information about the chromatogram into a single output. Namely, the model 200 may concatenate the tensor with the retention time difference (e.g., input 204) between the two peaks that are being compared at block 212. Thereafter, the model 200 may input the concatenated tensor into a second dense layer 216 that has a dropout layer of 0.20, a dense layer of 64 units, a ReLu activation layer, and a sigmoid output layer. The second dense layer 216 may be configured to output a similar binary prediction regarding whether the two chromatogram segments being compared are identical (e.g., output 220).

This functionality of the first example peak alignment model 200 is similar to the functionality of the second example peak alignment model 230 of FIG. 2B. In fact, the second example peak alignment model 230 differs from the first example peak alignment model 200 by eliminating the time difference input 204, and thereby utilizing the output from the Siamese network directly in the next branch. In other words, the second example peak alignment model 230 may include a similar input 232, CNN blocks 234, 236, absolute element-wise difference block 238, first dense layer 240, and output 244 as the corresponding elements from the first example peak alignment model 230. However, the second dense layer 242 and output 246 may differ from the first example peak alignment model 200 because the retention time difference between the pairs of chromatograms (e.g., input 204 of FIG. 2A) is not concatenated with the outputs from block 238 prior to input into the second dense layer 242.

FIG. 2C illustrates a third example peak alignment model 260 trained to align gas chromatography peaks, in accordance with various aspects disclosed herein. The third example peak alignment model 260 may generally have a similar architecture to the second example peak alignment model 230 that also includes a Siamese network (e.g., represented by blocks 270, 272, 278, 284, 290) configured to compare pairs of peak profiles (e.g., represented by input block 264). This Siamese network may be composed of two identical branches represented by blocks 270 and 272 that each include three stacked gated recurrent units (GRUs) (e.g., blocks 270a, 270b, 270c in the first block 270), and each stacked GRU 270a, 270b, 270c may have 10 units and/or any other suitable number of units. The first stacked GRU 270a and the second stacked GRU 270b may be followed by a normalization layer and a dropout layer of 0.20. The third stacked GRU 270c may return a hidden state that accumulates information/data characterizing the peak profile that was determined in the previous two GRU layers 270a, 270b. This hidden state may then proceed into a dropout layer of 0.20 and a dense layer with 10 units. Each of these outputs from the various GRU layers 270a, 270b, 270c may then be flattened at block 270d. It should be appreciated that these actions performed by the GRU layers 270a-270c and block 270d may also be simultaneously performed in the corresponding layers of block 272.

When the blocks 270, 272 have output the hidden states corresponding to the peak profiles, the third example peak alignment model 260 may proceed to analyze the hidden states at block 278. Similar to the convolutional blocks 266, 268 configured to compare segments of chromatograms, the outputs from the two blocks 270, 272 may be merged together at block 278 into a single tensor by taking the absolute element-wise difference. The third example peak alignment model 260 may analyze this tensor alone through block 278 and the third dense layer 284 to predict whether the two peaks being compared are identical based solely on the peak profiles input at block 264. In these instances, the convolutional blocks 266, 268 may also analyze the respective outputs through block 274 and the first dense layer 280 to generate the output represented by block 286 without considering the outputs from the GRU blocks 270, 272.

However, the third example peak alignment model 260 may also concatenate the tensor output by the GRU blocks 270, 272 with the outputs from the convolutional blocks 266, 268 at block 276 to predict whether the two peaks being compared are identical based on the outputs from both analysis branches represented by blocks 266, 268, 270, and 272. In these instances, the third example alignment model 260 may analyze the output through the second dense block 282 and generate a single value representing whether the peaks are identical, as represented by the output at block 288.

The training module 104b may train/optimize the peak alignment model 104c in accordance with any/all of these example models 200, 230, 260, for example, using a binary cross-entropy loss function with equal weights for all outputs and/or any other suitable training methodology or combinations thereof. In certain embodiments, and to prevent overfitting, the training module 104b may utilize an Adam optimizer with a starting learning rate of 0.01 and decreasing by a factor of 10 when the validation loss stops dropping for two consecutive epochs. Moreover, in some embodiments, the training module 104b may terminate training of the peak alignment model 104c if the validation loss does not improve for three consecutive epochs.

Advantageously, the training techniques and model architectures previously described improve over conventional techniques/architectures. Namely, the training module 104b training the peak alignment model 104c to perform analysis in the manner and utilizing the architecture described herein does not depend on any mass spectroscopy information corresponding to the input breath (or other gases), upon which, conventional techniques traditionally relied. Instead, and unlike conventional techniques, the present peak alignment models 104c are configured to determine similarities between different peaks in gas chromatograms using the neighboring peaks and the peak profile(s) only.

With the initial training done, the server (e.g., server 104) or other suitable computing device storing the peak alignment model 104c may input new chromatographic data (e.g., a chromatogram representing a breath of a user or patient) into the model 104c for analysis. The peak alignment model 104c may compare each peak in the new chromatographic data to some/all of the simulated peaks (or peaks from one or multiple non-simulated reference GCs) that may be a subset of the training data whose retention times are within one minute of the peaks in the new chromatographic data. Of course, the retention time limit may be any suitable value, and the retention time limit may more broadly represent a maximum time difference observed for the reference peaks in the aligned training dataset. Based on these comparisons, the peak alignment model 104c may then predict a set of probability scores indicating whether, or to what extent, the test peak (e.g., from the new chromatographic data) and the simulated peak are identical. These scores may be averaged per reference peak, which may be used in the preliminary assignment of each peak. More precisely, the test peak may be matched to the reference peak with the highest average probability score. However, this approach may not consider the position of the peak relative to neighboring peaks, which may lead to certain erroneous matchings or the assignment of multiple peaks to the same reference peak. To avoid these issues and generally improve the resulting peak alignment, the server 104 may also apply the post-processing algorithm 104d to the peak match probabilities output by the peak alignment model 104c.

In particular, the post-processing algorithm 104d may be or include a greedy optimization algorithm configured to optimize the peak matching. The post-processing algorithm 104d may cause the server to more optimally align the peaks by using a scoring metric that is based on a raw match probability (e.g., the peak match probabilities output by the peak alignment model 104c), or the product of the match probability and the total counts of the matches that are being tested between the peak and VOC, i.e., the sum of the match probabilities for each given peak-VOC pair over different reference GCs. In this way, the metric accounts for both the probabilities generated by the model and how often VOCs appear in the GC signals, i.e., the more prevalent the VOC is in the reference GCs, the more likely it is that the test peak will get matched to it.

The post-processing algorithm 104d may also include one or more heuristic-type parameters that must be satisfied prior to confirming a peak match. For example, the post-processing algorithm 104d may enforce a chronological order to the peaks that preserves the arrival time of the peaks between the new chromatographic data and the reference gas chromatogram. Additionally, or alternatively, the post-processing algorithm 104d may be configured to assume that the peaks in the test chromatogram preserve the order in which peaks appear in the reference chromatogram.

In any event, the post-processing algorithm 104d may cause the server to iterate through all possible matchings of detected and reference peaks, starting with the pair(s) having a highest score (e.g., likelihood of a correct peak match) to pair(s) with a lowest score. Through each iteration, the post-processing algorithm 104d may cause the server to determine that a peak matching is acceptable if it satisfies the following criteria. First, the post-processing algorithm 104d must not have assigned either the peak of interest or the reference peak to another peak/reference peak during a prior iteration. Additionally, and as mentioned, the post-processing algorithm 104d may not allow the candidate assignment to disrupt the natural ordering of the peaks as they appear in the reference chromatogram. Moreover, the post-processing algorithm 104d may not allow the matching process to result in any orphan peaks, or peaks that cannot be matched to any reference peaks in the remaining/following iterations. In this manner, the post-processing algorithm 104d may ensure that the server may create an optimal and unique bijective mapping between the detected peaks (e.g., from the new chromatographic data) and reference peaks, and that the bijective mapping preserves the chronological order of the referenced peaks.

Additionally or alternatively, the post-processing algorithm 104d may use another optimization approach to ensure that the final matching between the peak in the test GC and the VOCs in the reference GCs adhere to predetermined constraints, such as the natural ordering of the VOCs, as described above. For example, the post-processing algorithm 104d may utilize an Integer Program composed of an objective function and a set of constraints to find the optimal matching. In this approach, the objective function will minimize the aggregate matching performance over all the peaks and VOCs, and the constraints will ensure the resulting matching adheres to the previously defined criteria, e.g., the matched VOCs should appear in their natural order, no peaks should be left orphan (not assigned to any VOCs) or any suitable relaxed version of such requirement(s) (limiting the number of orphan peaks). The binary variables that are used in this Integer Program may encode the matching between peaks and VOCs. The post-processing algorithm 104d may thereby solve the Integer Program using any existing solvers for discrete optimization.

One example of such an integer program is

$$Maximize {\sum }_{p} {\sum }_{v} {W}_{p v} {X}_{p v} \qquad ( 1 )$$

$$subject to$$

$${\sum }_{p} {X}_{p v} \leq 1 , ∀ v ∈ [ 1 , {n}_{v} ] \qquad ( 2 )$$

$${\sum }_{v} {X}_{p v} = 1 , ∀ p ∈ [ 1 , {n}_{v} ] \qquad ( 3 )$$

$${X}_{{p}_{r}}^{T} t < {X}_{p + 1 , .}^{T} t , ∀ p ∈ [ 1 , {n}_{p} - 1 ] \qquad ( 4 )$$

$${X}_{pv} ∈ \{ 0 , 1 \} , ∀ p ∈ [ 1 , {n}_{v} ] , ∀ v ∈ [ 1 , {n}_{v} ] \qquad ( 5 )$$

where Wₚᵥ is the similarity of peak p to VOC v (i.e., the match probabilities generated by the alignment model discussed above), Xₚᵥ is the binary variable determining whether peak p is matched to VOC v, t is the vector that contains the times of the VOCs in the reference GC signal, nᵥ is the number of VOCs in the training data, and np is the number of peaks in the test GC. The objective function represented by equation (1), finds the peak to VOC matching, Xₚᵥ, that maximizes the sum of the match probabilities associated with that mapping, i.e., Xₚᵥ is 1 when peak p is matched to VOC v. The first constraint represented by equation (2) ensures that no more than one peak is matched to each VOC. The second constraint represented by equation (3) ensures that each peak is matched exactly to one VOC. The third constraint represented by equation (4) ensures that the order of the matched VOCs adheres to the order of VOCs in a reference GC. As included in equation (4), Xₚ, refers to the pth row of matrix X, i.e., a one-hot vector (a vector with zeros in all positions except a single one) that determines which VOC the peak p is assigned to. This is done by ensuring that the time of the VOC that the p^{th} peak is assigned to (left side of the constraint represented by equation (4)) is smaller than the time of the VOC that the (p+1)^{th} peak is assigned to (right side of the constraint represented by equation (4)). This constraint of equation (4) may assume that the indices p correspond to the peaks in the order they appear in the test GC, i.e., peak p appears before peak p+1 in the test GC. The last constraint represented by equation (5) ensures that X is a binary matrix.

It should be appreciated that the integer program represented by equations (1)-(5) is for the purposes of discussion only. There may be numerous other formulations of such an integer program that may result in identical or similar solutions. For example, the integer program represented above by equations (1)-(5) may ensure that every peak in the test GC is assigned to exactly one VOC. However, other formulations of this integer program can be used that may relax this requirement, i.e., allow for some peaks to not be assigned to any VOC.

In any event, as part of the execution of the post-processing algorithm 104d, the server may also estimate the time warping function using the peaks that are matched to a reference peak. The server may also then interpolate the time warping function to determine the aligned locations for the detected unaligned peaks. Further, the post-processing algorithm 104d may cause the server to map the aligned locations to a closest reference peak that is within a threshold distance from the interpolated location. The threshold distance may be any suitable value and may be based on the known/presumed maximum time distance of identical peaks within two samples. This additional processing to determine the correct peak assignment ensures that the aligned location falls between midpoints of the reference peak and the two neighboring peaks. In this manner, the peaks that are not mapped during the matching portion of the post-processing algorithm 104d may also be matched to the remaining unmapped reference peaks, while the peaks that are aligned as a result of the matching portion of the post-processing algorithm 104d may remain intact.

Thus, the simulation, training, and execution actions described herein, provide a fully automated pipeline for GC analysis, in a manner that is unachievable by conventional techniques. This alignment pipeline (e.g., simulation module 104a1, training module 104b, peak alignment model 104c, post-processing algorithm 104d) performs at a high level and shows that a deep-learning model trained on simulated chromatogram data and processed in an appropriate manner can accurately and efficiently align chromatograms to an extent not possible with conventional techniques. In particular, and as discussed in reference to the simulation module 104a1, the approach of the present disclosure is especially effective due to the small number of initially aligned gas chromatograms needed to successfully train the peak alignment model 104c.

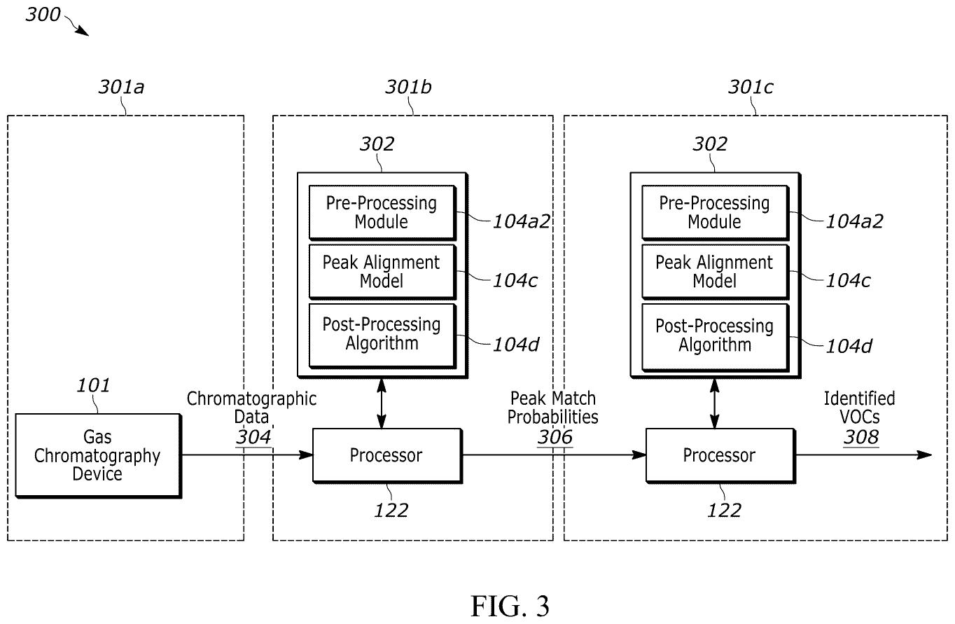

FIG. 3 illustrates an example data workflow 300 for aligning gas chromatography peaks, as utilized by the example system 120 of FIG. 1B, and in accordance with various aspects disclosed herein. Broadly, the example data workflow 300 may include three stages: receiving chromatographic data 304 of a user from a GC device 101 (a first stage 301a), analyzing the chromatographic data 304 to determine peak match probabilities 306 (a second stage 301b), and generating a set of identified VOCs 308 between the chromatographic data 304 and the set of reference VOCs (a third stage 301c). It should be appreciated that the example data workflow 300 may utilize any suitable components from the example system 120 and/or the example environment 100 of FIG. 1A, and is not limited to the components (e.g., processor 122) illustrated in FIG. 3.

As mentioned, the first stage 301a may generally involve receiving chromatographic data 304 of a user from a GC device 101. The GC device 101 may receive a breath sample from the user and may process the breath sample to generate chromatographic data 304, as described herein. Based on the chromatographic data 304, the GC device 101 may generate a gas chromatograph representing the various VOCs present in the breath sample, and as reflected in the chromatographic data 304. The chromatographic data 304 of a user may typically include data representing multiple VOCs, but in certain embodiments, the chromatographic data 304 should represent/include at least one VOC. Accordingly, when the GC device 101 generates the gas chromatograph corresponding to the chromatographic data 304, the GC device 101 may transmit the gas chromatograph to the server (e.g., server 104), where it is analyzed by the processor 122.

The server may receive the chromatographic data 304 (represented as a gas chromatogram) from the GC device 101 and may cause the processor to execute instructions stored in the first location 302 (e.g., memory 126) corresponding to the peak alignment model 104c to analyze the chromatographic data 304 in the second stage 301b. More specifically, the processor 122 may execute the peak alignment model 104c to analyze the chromatographic data 304 and output a set of peak match probabilities 306. As previously described, the peak alignment model 104c may be trained using a plurality of training chromatographic data to output a plurality of training sets of peak match probabilities. Further, the set of peak match probabilities 306 may generally be or include likelihood values corresponding to various candidate peak matches between peaks in the chromatographic data 304 and peaks in the reference (e.g., simulated) chromatograms.

When the processor 122 has successfully executed the peak alignment model 104c to determine the set of peak match probabilities 306, the processor 122 may proceed to execute the post-processing algorithm 104d in the third stage 301c. The post-processing algorithm 104d may include various instructions configured to cause the processor 122 to analyze the peak match probabilities 306 in tandem with certain criteria (e.g., chronology preservation, no orphan peaks, no prior peak/reference peak assignments) that may optimize the peak matches, and thereby minimize the rate of false positive and/or otherwise erroneous peak matches. Accordingly, the processor 122 may execute the post-processing algorithm 104d to generate a set of identified VOCs 308 between the chromatographic data 304 and a set of reference VOCs. The identified VOCs 308 may generally be or include indications of a particular VOC represented by the peak of interest. For example, a first identified VOC may indicate that a first peak of interest included as part of a user's chromatographic data 304 corresponds to the presence of a first VOC within their breath, and a second identified VOC may indicate that a second peak of interest included as part of the user's chromatographic data 304 corresponds to the presence of a second VOC within their breath.

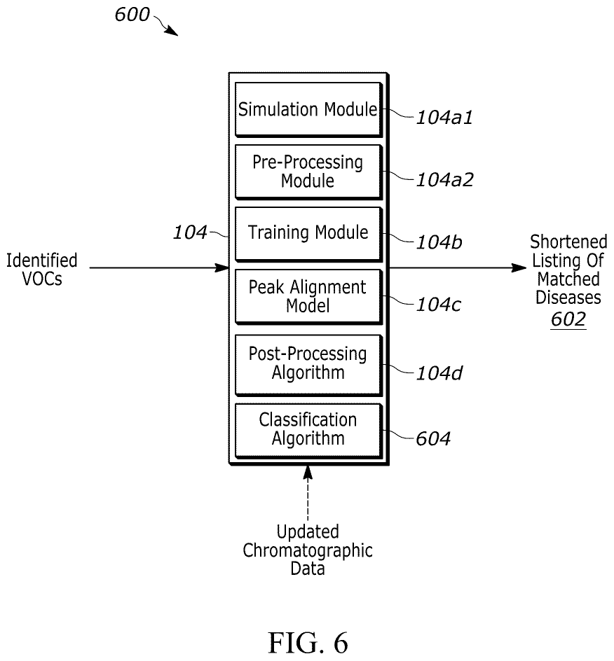

These identified VOCs 308 output by the processor 122 as a result of executing the post-processing algorithm 104d may be displayed to a user in response to their generation. Namely, the processor 122 may cause the identified VOCs 308 to be displayed on a display device (e.g., display screen 124a) for viewing and/or other interpretation by a user. As part of this display, the processor 122 may further accompany the identified VOCs 308 with predetermined and/or otherwise known explanations for what each of the identified VOCs 308 may indicate. For example, the processor 122 may cause a first identified VOC to be displayed to the user, and may further cause the display to indicate that the presence of the first identified VOC in chromatographic data 304 is generally indicative of a user having asthma. In any event, when the processor 122 causes the identified VOCs 308 to be displayed to a user, the processor 122 may wait for further instructions in response to user interactions with the device (e.g., user device 108) on which the identified VOCs 308 are displayed. Moreover, any/all of the identified VOCs 308, gas chromatograms, and/or any other data described herein may be used to train and/or apply a classification or regression algorithm configured to provide diagnoses, prognoses, and/or severity assessments associated with various medical conditions, as discussed herein in reference to FIG. 6.

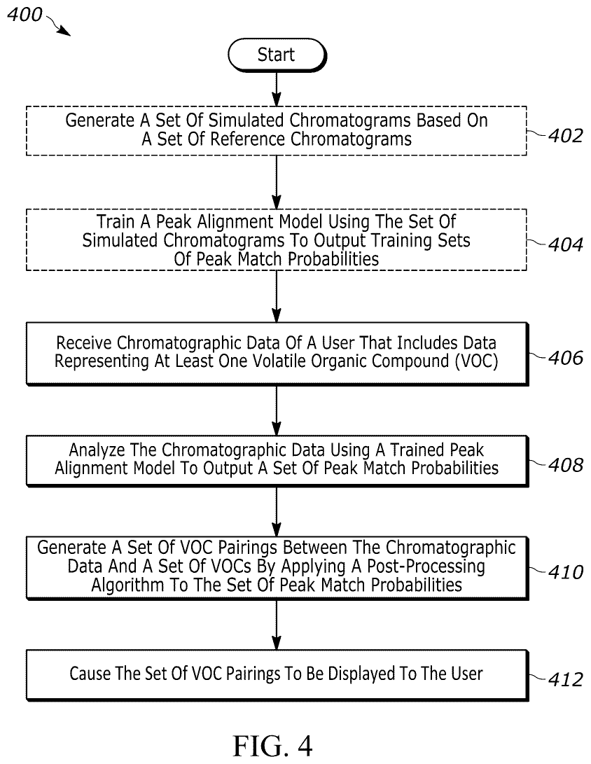

FIG. 4 illustrates an example method 400 for aligning gas chromatography peaks, in accordance with various aspects disclosed herein. For case of discussion, many of the various actions included in the method 400 may be described herein as performed by or with the use of a processor (e.g., processor 122). However, it is to be appreciated that the various actions included in the method 400 may be performed by, for example, any suitable processing device (e.g., server 104, user device 108, example system 120) executing the simulation module 104a1, the training module 104b, the peak alignment model 104c, the post-processing algorithm 104d, and/or other suitable modules/models/applications or combinations thereof.

The example method 400 optionally includes generating a set of simulated chromatograms based on a set of reference chromatograms (block 402). The plurality of training chromatographic data may be the set of simulated chromatograms. The example method 400 may further optionally include training a peak alignment model using the set of simulated chromatograms to output training sets of peak match probabilities (block 404). As a result of this training, the peak alignment model may thereafter be configured to receive chromatogram data and/or other suitable data or combinations thereof as inputs, and may output peak match probabilities, as described herein.

Additionally, or alternatively, the example method 400 may also include the receiving chromatographic data of a user that includes data representing at least one VOC (block 406). In some embodiments, the chromatographic data may be a one-dimensional (1D) chromatogram. The example method 400 may also include analyzing the chromatographic data using a trained peak alignment model to output a set of peak match probabilities (block 408). The trained peak alignment model may be trained using a plurality of simulated chromatographic data to output a plurality of training sets of peak match probabilities. The example method 400 may also optionally include generating a set of identified VOCs between the chromatographic data and a set of reference VOCs by applying a post-processing algorithm to the set of peak match probabilities (block 410).

Moreover, in certain embodiments, the peak alignment model may be unable to match identified peaks within the chromatographic data to VOCs with a certainty that satisfies a certainty threshold. In these embodiments, to identify when the peak alignment model fails to map the peaks to VOCs with certainty levels satisfying the certainty threshold, the method 400 may further include determining whether the patterns present in the chromatographic data are similar to the patterns that the alignment model was trained on (and/or to known patterns present in chromatographic data when a gas chromatogram device is not noisy). This determination may utilize and/or be based on one or more of (i) a distribution of the peak match probabilities for the peaks that are mapped to a VOC (e.g., the max, mean, median, and/or standard deviation of the peak match probabilities), and/or (ii) a morphology deep learning model (e.g., CNN, RNN, LSTM, GRU, transformer) trained to analyze the morphology of the input chromatographic data. For example, when the peak alignment model outputs certainty levels that fail to satisfy the certainty threshold, the morphology model may analyze the chromatographic data and output indeterminate results indicating that the alignment has failed, such that the matching results should not be trusted.

In certain embodiments, the trained peak alignment model may be a deep learning model including one or more of: (i) a convolutional neural network (CNN) and/or (ii) a recurrent neural network (RNN) with a gated recurrent unit (GRU).

In some embodiments, the post-processing algorithm may be at least one of: (i) a greedy optimization algorithm, (ii) an Integer Program algorithm, and/or (iii) a Naïve Bayes algorithm.

In certain embodiments, the example method 400 may further include applying the post-processing algorithm by: (a) determining, by the one or more processors, whether a chronology of the chromatographic data corresponds to a predetermined chronology of the set of reference VOCs. Further in these embodiments, the example method 400 may further include: (b) analyzing, by the one or more processors, the set of identified VOCs to determine whether any peaks from the chromatographic data are orphan peaks; and responsive to determining that (a) and (b) are satisfied, generating, by the one or more processors, the set of identified VOCs.

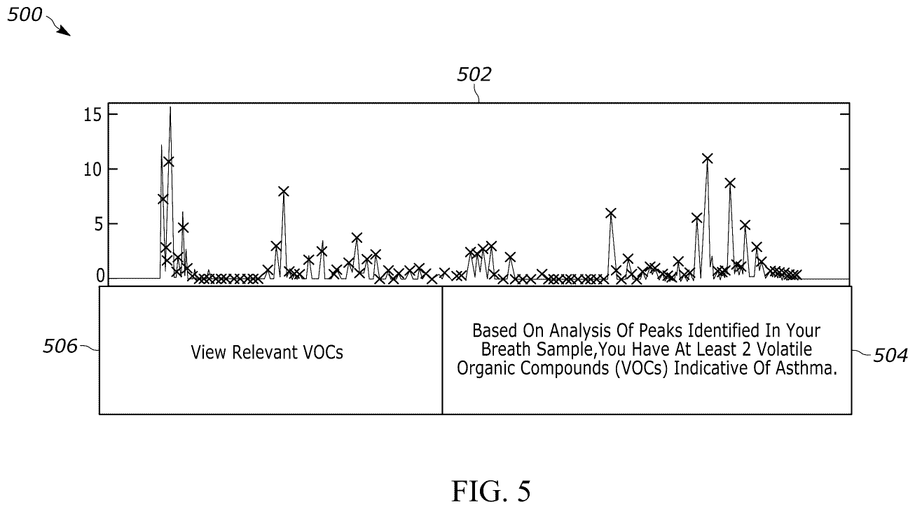

Moreover, the example method 400 may also include causing the set of identified VOCs to be displayed to the user (block 412). For example, FIG. 5 depicts an example user interface display 500 enabling a user to view aligned gas chromatography peaks and a predicted diagnosis associated with VOCs corresponding to the aligned peaks, in accordance with various aspects disclosed herein. In particular, as illustrated in FIG. 5, the user device (e.g., user device 108) may render a display that includes a graphical display portion 502, a textual display portion 504, and an interactive button display portion 506.

The graphical display portion 502 may include the user chromatographic data, represented as a gas chromatogram. The gas chromatogram may feature various peaks that have markings (e.g., “X”) indicating which peaks may have been analyzed as part of the execution of the peak alignment model and/or the post-processing algorithm. The graphical display portion 502 may be interactive, such that a user may interact (e.g., click, tap, swipe, touch, gesture, etc.) with the graphical display portion 502, and the example user interface display 500 may display additional and/or otherwise different information than illustrated on the graphical display portion 502. For example, a user may interact with the graphical display portion 502 by tapping on an individual peak of the gas chromatogram, and as a result, the processors may cause the example user interface display 500 to display additional information concerning the VOC represented by the individual peak, such as the name of the VOC, implications of the VOC (e.g., potential medical implications of the presence of the VOC in the user's breath), and/or any other suitable data/information or combinations thereof.

Further, each of the peaks and/or any other suitable information/data/objects represented on the graphical display portion 502 may be and/or otherwise include any suitable type of text, symbols, patterns, colors, and/or any other suitable visual indicia. For example, as illustrated in FIG. 5, the recognized peaks of the chromatographic data that may have been analyzed as part of the execution of the peak alignment model and/or the post-processing algorithm may be marked with the marking “X”. Moreover, each object represented on the graphical display portion 502 may be or include an image, video, and/or any other suitable visual display configuration.

Further, in certain embodiments, the graphical display portion 502 may include indications that represent strength or other gradient values corresponding to the data displayed in the graphical display portion 502. For example, the peak markings may include graphical relative strength indicators (e.g., colors, symbols, graphics, etc.) corresponding to a level of concern a user may have as a consequence of the presence of the VOC represented by the peak being present in the user's chromatographic data, numerical representations of the level of concern, textual strength indicators (e.g., “seek immediate medical attention”, “benign”, etc.), and/or any other suitable indicator types or combinations thereof.

The textual display portion 504 may include a text-based message for a user that corresponds to the display within the graphical display portion 502. For example, as illustrated in FIG. 5, the textual display portion 504 includes text reading “Based on analysis of peaks identified in your breath sample, you have at least 2 volatile organic compounds (VOCs) indicative of asthma.” Thus, the text-based message within the textual display portion 504 may enable a user to understand the context of the display within the graphical display portion 502, and as a result, the user may make more informed decisions to seek medical attention/advice regarding a potential asthma diagnosis. In this manner, the textual display portion 504 may enable the user to alleviate/mitigate risk associated with having asthma.

The interactive button display portion 506 may generally enable a user to view additional information and/or initiate certain additional functionalities corresponding to the information presented in the example user interface display 500. For example, a user may interact with the interactive button display portion 506, and the processor may cause the example user interface display 500 to display relevant VOCs that are present within the user's chromatographic data. These relevant VOCs may be or include the two VOCs indicated in the message of the textual display portion 504. Additionally, or alternatively, the interactive button display portion 506 may cause the processor to initiate functionality outside of a display application or other application/module where the example user interface display 500 is rendered in the event, for example, that a user may desire to contact a physician's office to discuss the results of their chromatographic data analysis and/or any other suitable additional functionality or combinations thereof. As another example, the user may interact with the interactive button display portion 506, and the processor may access the Internet to retrieve and display information related to any VOCs that are flagged and/or otherwise determined as relevant within the user's chromatographic data.

FIG. 6 depicts an example disease and trajectory monitoring sequence, in accordance with various aspects disclosed herein. As illustrated in FIG. 6, the central server 104 may receive the identified VOCs from a previously analyzed set of chromatographic data (e.g., a user's prior breath sample), may receive a set of updated chromatographic data (e.g., a user's recent breath sample), and may proceed to determine a shortened listing of matched diseases 602. Generally speaking, the shortened listing of matched diseases 602 may be, include, and/or otherwise correspond to (i) one or more diseases that a user is predicted to have based on the analysis performed on the user's identified VOCs and the user's updated chromatographic data, (ii) a prognosis for a particular disease or condition from which the user's identified VOCs and updated chromatographic data may indicate the user may be suffering, (iii) the severity of a disease that the user may be suffering from, and/or may also include any other suitable values or combinations thereof or described herein. Of course, the example disease and trajectory monitoring sequence depicted in FIG. 6 is exemplary and for the purposes of discussion only. Such monitoring, diagnostics, prognostics, tracking, severity evaluation, and/or other functions described herein may be performed using any of the modules or other components described herein and any of the data described herein.

As an example, the classification/regression algorithm 604 may be a classification model (e.g., leveraging AI or ML) trained to detect various diseases using chromatographic data and/or identified VOCs from such chromatographic data. Namely, the classification model 604 may be trained to output disease diagnoses/prognoses/severity measures/values using training chromatographic data from patients with various diseases along with training sets of such diagnoses/prognoses/severity measures/values. This training process for the classification model 604 may also include various controls, such as using features of the identified VOCs (e.g., measured areas/intensities of the identified VOCs in the chromatogram data) to train the classification model 604. Thus, in this example, the classification model 604 may receive chromatogram data and/or identified VOCs from such chromatogram data, and may proceed to generate the shortened listing of matched diseases 602, which may be or include various predicted disease diagnoses, prognoses, severity values/measures, and/or any other suitable values or combinations thereof.

As another example, a user may provide a first breath sample (or other suitable inputs) to a GC device (e.g., GC device 101) at a first time, and the classification/regression algorithm 604 may analyze that breath sample as described herein to determine the identified VOCs. The user may subsequently provide a second breath sample to the GC device 101 at a second time (different from the first time), and the classification/regression algorithm 604 may receive this second breath sample as the updated chromatographic data. Consequently, the classification/regression algorithm 604 may analyze the identified VOCs from the user's first breath sample in tandem with any identified VOCs in the updated chromatographic data from the user's second breath sample to characterize and quantify the presence of VOCs in the user's breath samples over time. In this manner, the central server 104 (e.g., via the classification/regression algorithm 604) may effectively and accurately track the progress, development, and/or severity of any predicted diseases and/or other conditions from which the user may be suffering.

In the prior example, the classification/regression algorithm 604 may interpret the identified VOCs from the user's first breath sample to determine that a first VOC and a second VOC are present in the user's breath at uncommonly high proportions at the first time. As a result, the classification/regression algorithm 604 may determine that the user is suffering from a first condition/disease. At the second time, the classification/regression algorithm 604 may analyze the identified VOCs from the user's second breath sample to determine that the first VOC and the second VOC are significantly less present in the user's breath at the second time. The classification/regression algorithm 604 may then compare this analysis of the updated chromatographic data with the prior analysis of the identified VOCs from the first time to determine that the user's condition/disease may be improving. The classification/regression algorithm 604 may thereby provide users with diagnoses, prognoses, and/or severity values/measures of diseases/conditions through progressively updated analysis of a user's chromatographic data.

As mentioned, it should be appreciated that the classification/regression algorithm 604 may utilize ML and/or any other suitable techniques, as described herein. The classification/regression algorithm 604 may be trained using sets of training identified VOCs, sets of training updated chromatographic data, and sets of matching diseases/conditions. As a result, the classification/regression algorithm 604 may be trained to output lists of matched diseases (e.g., shortened listing of matched diseases 602), which may be or include disease diagnosis, prognosis, severity, tracking, and/or any other suitable metric or values associated with disease/condition evaluation.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment,” “one aspect,” “an aspect,” or “an embodiment” means that a particular element, feature, structure, or characteristic described in connection with the embodiment is included in at least one embodiment/aspect. The appearances of the phrase “in one embodiment” or “in one aspect” in various places in the specification are not necessarily all referring to the same embodiment/aspect.

Some embodiments/aspects may be described using the expression “coupled” and “connected” along with their derivatives. For example, some embodiments/aspects may be described using the term “coupled” to indicate that two or more elements are in direct physical or electrical contact. The term “coupled,” however, may also mean that two or more elements are not in direct contact with each other, but yet still co-operate or interact with each other. The embodiments/aspects are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments/aspects herein. This is done merely for convenience and to give a general sense of the description. This description, and the claims that follow, should be read to include one or at least one and the singular also includes the plural unless it is obvious that it is meant otherwise.

While the present invention has been described with reference to specific examples, which are intended to be illustrative only and not to be limiting of the invention, it will be apparent to those of ordinary skill in the art that changes, additions and/or deletions may be made to the disclosed embodiments/aspects without departing from the spirit and scope of the invention.

The foregoing description is given for clearness of understanding; and no unnecessary limitations should be understood therefrom, as modifications within the scope of the invention may be apparent to those having ordinary skill in the art.

What is claimed:

1. A method for aligning gas chromatography peaks, the method comprising:
receiving, at one or more processors, chromatographic data of a user that includes data representing at least one volatile organic compound (VOC);
analyzing, by the one or more processors, the chromatographic data using a trained peak alignment model to output a set of peak match probabilities, wherein the trained peak alignment model is trained using a plurality of training chromatographic data to output a plurality of training sets of peak match probabilities;
generating, by the one or more processors, a set of identified VOCs between the chromatographic data and a set of reference VOCs by applying a post-processing algorithm to the set of peak match probabilities; and
causing, by the one or more processors, the set of identified VOCs to be displayed to the user.

2. The method of claim 1, further comprising:
generating, by the one or more processors, a set of simulated chromatograms based on a set of reference chromatograms, and
wherein the plurality of training chromatographic data is the set of simulated chromatograms.

3. The method of claim 1, wherein the chromatographic data is a one-dimensional (1D) chromatogram.

4. The method of claim 1, wherein the trained peak alignment model is a deep learning model including one or more of: (i) a convolutional neural network (CNN) or (ii) a recurrent neural network (NN), (iii) a long short-term memory network, (iv) a gated recurrent unit (GRU), or (v) a transformer network.

5. The method of claim 1, wherein the post-processing algorithm is at least one of: (i) a greedy optimization algorithm, (ii) an Integer Program algorithm, or (iii) a Naïve Bayes algorithm.

6. The method of claim 1, wherein applying the post-processing algorithm further comprises:
determining, by the one or more processors, whether a chronology of the chromatographic data corresponds to a predetermined chronology of the set of reference VOCs;
analyzing, by the one or more processors, the set of identified VOCs to determine whether any peaks from the chromatographic data are orphan peaks; and
responsive to determining that (i) the chronology corresponds to the predetermined chronology and (ii) no peaks from the chromatographic data are orphan peaks, generating, by the one or more processors, the set of identified VOCs.

7. The method of claim 1, further comprising:
receiving, at the one or more processors, updated chromatographic data associated with the user;
analyzing, by the one or more processors, the updated chromatographic data using the trained peak alignment model to output an updated set of peak match probabilities;
generating, by the one or more processors, a set of updated identified VOCs between the updated chromatographic data and the set of reference VOCs by applying the post-processing algorithm to the updated set of peak match probabilities; and
generating, by the one or more processors, a shortened listing of matched diseases based on features of the set of identified VOCs and features of the set of updated identified VOCs.

8. A system for aligning gas chromatography peaks, the system comprising:
a memory storing a set of computer-readable instructions; and
one or more processors interfacing with the memory, and configured to execute the set of computer-readable instructions to cause the one or more processors to:
receive chromatographic data of a user that includes data representing at least one volatile organic compound (VOC),
analyze the chromatographic data using a trained peak alignment model to output a set of peak match probabilities, wherein the trained peak alignment model is trained using a plurality of training chromatographic data to output a plurality of training sets of peak match probabilities,
generate a set of identified VOCs between the chromatographic data and a set of reference VOCs by applying a post-processing algorithm to the set of peak match probabilities, and
cause the set of identified VOCs to be displayed to the user.

9. The system of claim 8, wherein the instructions, when executed, further cause the one or more processors to:
generate a set of simulated chromatograms based on a set of reference chromatograms, and
wherein the plurality of training chromatographic data is the set of simulated chromatograms.

10. The system of claim 8, wherein the chromatographic data is a one-dimensional (1D) chromatogram.

11. The system of claim 8, wherein the trained peak alignment model is a deep learning model including one or more of: (i) a convolutional neural network (CNN), (ii) a recurrent neural network (NN), (iii) a long short-term memory network, (iv) a gated recurrent unit (GRU), or (v) a transformer network.

12. The system of claim 8, wherein the post-processing algorithm is at least one of: (i) a greedy optimization algorithm, (ii) an Integer Program algorithm, or (iii) a Naïve Bayes algorithm.

13. The system of claim 8, wherein applying the post-processing algorithm further comprises:
determining whether a chronology of the chromatographic data corresponds to a predetermined chronology of the set of reference VOCs.

14. The system of claim 13, wherein the instructions, when executed, further cause the one or more processors to:
analyze the set of identified VOCs to determine whether any peaks from the chromatographic data are orphan peaks; and
responsive to determining that (i) the chronology corresponds to the predetermined chronology and (ii) no peaks from the chromatographic data are orphan peaks, generate the set of identified VOCs.

15. A non-transitory computer-readable storage medium having stored thereon a set of instructions, executable by at least one processor, for aligning gas chromatography peaks, the instructions comprising:
instructions for receiving chromatographic data of a user that includes data representing at least one volatile organic compound (VOC);
instructions for analyzing the chromatographic data using a trained peak alignment model to output a set of peak match probabilities, wherein the trained peak alignment model is trained using a plurality of training chromatographic data to output a plurality of training sets of peak match probabilities;
instructions for generating a set of identified VOCs between the chromatographic data and a set of reference VOCs by applying a post-processing algorithm to the set of peak match probabilities; and
instructions for causing the set of identified VOCs to be displayed to the user.

16. The non-transitory computer-readable storage medium of claim 15, wherein the instructions further comprise:
instructions for generating a set of simulated chromatograms based on a set of reference chromatograms, and
wherein the plurality of training chromatographic data is the set of simulated chromatograms.

17. The non-transitory computer-readable storage medium of claim 15, wherein the chromatographic data is a one-dimensional (1D) chromatogram.

18. The non-transitory computer-readable storage medium of claim 15, wherein the trained peak alignment model is a deep learning model including one or more of: (i) a convolutional neural network (CNN), (ii) a recurrent neural network (NN), (iii) a long short-term memory network, (iv) a gated recurrent unit (GRU), or (v) a transformer network.

19. The non-transitory computer-readable storage medium of claim 15, wherein the post-processing algorithm is at least one of: (i) a greedy optimization algorithm, (ii) an Integer Program algorithm, or (iii) a Naïve Bayes algorithm.

20. The non-transitory computer-readable storage medium of claim 15, wherein applying the post-processing algorithm further comprises:
(a) instructions for determining whether a chronology of the chromatographic data corresponds to a predetermined chronology of the set of reference VOCs;
(b) instructions for analyzing the set of identified VOCs to determine whether any peaks from the chromatographic data are orphan peaks; and
responsive to determining that (a) and (b) are satisfied, instructions for generating the set of identified VOCs.
